(19) United States
(12) Patent Application Publication
(10) Pub. No.: US 2004/0039812 A1
(43) Pub. Date: Feb. 26, 2004

(54) Method of collecting data from heterogeneous test and measurement device and apparatus using same

(76) Inventors: Stephen P. Connelly, Campbell, CA (US); John M. Monk, Colorado Springs, CO (US)

Correspondence Address: AGILENT TECHNOLOGIES, INC., Intellectual Property Administration, Legal Department, M/S DL429, P.O. Box 7599, Loveland, CO, 80537-0599, US

(21) Appl. No.: 10/225,142

(22) Filed: Aug. 22, 2002

(51) Int. Cl. G06F 15/173

(52) U.S. Cl. 709/224

(57) ABSTRACT

A method of collecting data from a heterogeneous test and measurement device and an apparatus using same. A measurement device such as a VQT or a DNA measures a network and generates measurement data according to a protocol. The data is encoded into a protocol independent format such as XML. The encoded data is sent via an IP network, and decoded prior to receipt by a client.

### BACKGROUND OF THE INVENTION

1. Field of the Invention

The present invention relates to a method of collecting measurement data from a measurement device, independent of a protocol of the measurement device, and an apparatus using same.

2. Description of the Related Art

FIG. 1 is a block diagram of a conventional communications network 100. The communications network 100 receives a request from a client 12. Based upon the nature of the request, a router 114 transports the request along one of two paths. If the client 12 requests a file, the request is sent to a FTP API 102, which stands for File Transfer Protocol (FTP) Application Programming Interface (API) 102. The request is then sent to a first FTP transporter 104, which is a client-side transporter. An Internet Protocol (IP) network 30 provides a path to transfer the request to a second FTP transporter 106, which is a server side transporter, and the requested file is transported back to the client 12 over the same route as the request, in the reverse direction. NTE FTP SERVER by MICROSOFT is an example of a commercially available product which may be used as the FTP transporters 104, 106.

If the client 12 requests measurement data relating to a measured network 70, then the router 114 transports the request to a first Simple Network Management Protocol (SNMP) transporter 122, which is a client side transporter. The request is then transported via the IP network 30 to a second SNMP transporter 124, which is a server side transporter, which transports the request to a measurement device 60. Examples of commercial products which may be used as the SNMP transporters 122,124 include NETAPHOR and WIND RIVER.

The measurement device 60 then measures the measured network 70 based upon the request from the client 12 according to a particular protocol, to generate measurement data. The measurement device 60 may measure such items as protocol vitals, packet loss, packets per second, dropped packets, etc., as discussed above. The measurement data is sent to the client 12 over the same route as the request, in the reverse direction. The measurement device 60 may be a voice quality tester (VQT), or a DNA.

The conventional network 100 is a homogeneous network which can only support a single protocol. Thus, if measurement devices are changed or added, the new measurement devices must operate according to the particular protocol of the original measurement device. Thus, the availability of replacement devices is limited, and the ability to “shop around” between different vendors is likewise limited. Furthermore, there is limited ability to integrate the conventional network into the software of different clients. Thus, the conventional network must be customized for each different client.

### SUMMARY OF THE INVENTION

Accordingly, the present invention overcomes the above disadvantages of the conventional network.

The present invention also provides a heterogenous test method which can collect data from a measurement device independent of a protocol, and an apparatus using same.

Additional objects and advantages of the invention will be set forth in part in the description which follows and, in part, will be obvious from the description, or may be learned by practice of the invention.

The foregoing and other advantages of the present invention are achieved by providing a method of collecting measurement data in a system including a client side and a measurement device. The method includes (a) requesting the measurement data at the client side, (b) generating the measurement data from the measurement device according to a protocol, in accordance with the request, and (c) collecting the generated measurement data at the client side independent of the protocol.

The foregoing and other advantages of the present invention are also achieved by providing a communications network to transmit measurement data having a protocol. The communications network includes a first side to generate a request for the measurement data and to collect the measurement data independent of the protocol, and a second side to generate the measurement data in response to the request.

The foregoing and other advantages of the present invention are also achieved by providing a communications network to transmit measurement data according to a request from a client. The communications network includes a first side, including a first encoder to encode the request into an XML format, and a transporter to transport the encoded request. The communications network also includes a second side, including a container to receive the transported request, a second decoder to decode the received request, a measurement device to generate raw data in accordance with the received request, and a second encoder to encode the generated raw data into the XML format.

### BRIEF DESCRIPTION OF THE DRAWINGS

These and other objects and advantages of the invention will become apparent and more readily appreciated from the following description of the preferred embodiments, taken in conjunction with the accompanying drawings of which:

FIG. 1 is a block diagram of a conventional communications network;

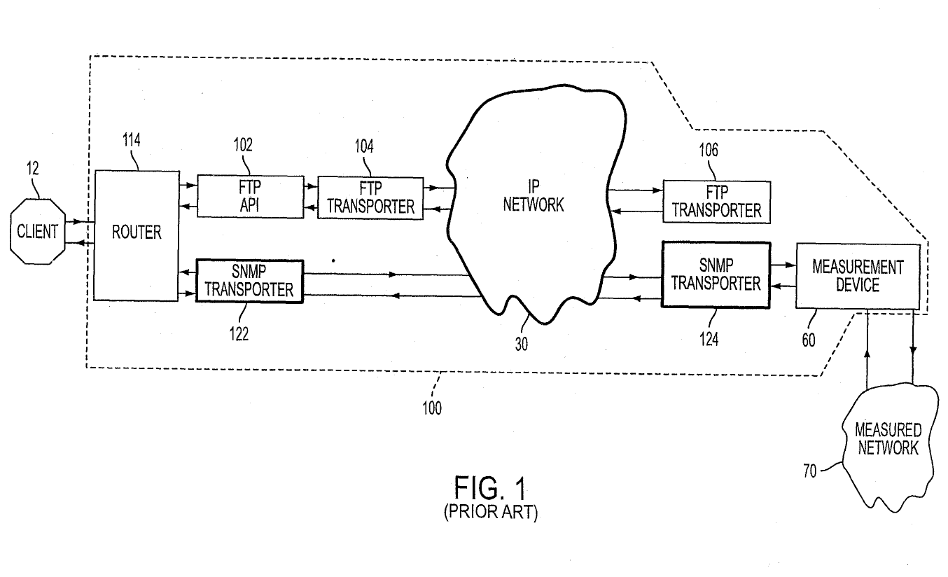

FIG. 2 is a block diagram of a communications network according to the present invention; and

FIG. 3. is a flow diagram of the operation of the network of FIG. 2.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to like elements throughout.

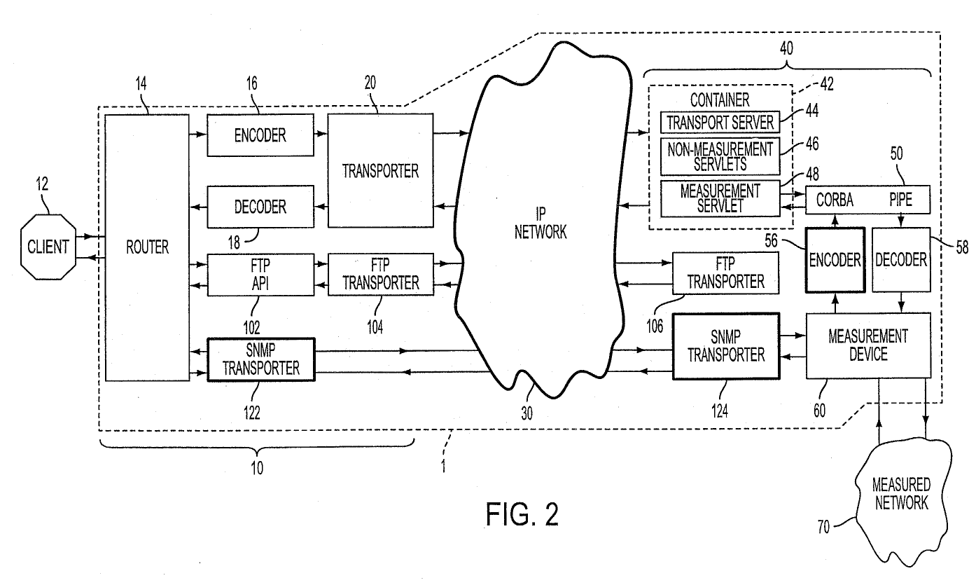

FIG. 2 is a block diagram of a communications network 1 according to the present invention. FIG. 2 illustrates the API architecture, high level view, of the network 1, which includes a first side 10, which is a client side, and a second side 40, which is a server side. The IP network 30 connects the first side 10 and the second side 40. The client 12 generates a request for measurement data, and the first side 10 includes a router 14 to route the request for measurement data (as discussed below). The first side 10 also includes a first side encoder 16 to encode the request into a protocol-independent format. For example, the first side encoder 16 may be an XML (Extensible Markup Language) document writer to encode the request into an XML format. The first side 10 also includes a transporter 20 to transport the encoded request to the second side 40 via the IP network 30. The transporter 20 may operate according to Hyper Text Transfer Protocol (HTTP), Simple Object Access Protocol (SOAP), or other known protocols.

The second side 40 includes a container 42, which includes a transport server 44, non-measurement servlets 46, and measurement servlets 48. Examples of commercial products which may be used as the container 42 include APACHE JAKARTA. The transport server transports the encoded request to the measurement servlet 48. The non-measurement servlets 46 handle information unrelated to the requested measurement data, for example, a state of the container 42 itself, or other administrative-type interactions. The second side 40 further includes a CORBA pipe 50 to receive and relay the encoded request to a second side decoder 58, which decodes the encoded request. In this example, the second side decoder 58 may be an XML document parser, which extracts the request which has been encoded into XML form. Examples of commercial products which may be used as the second side decoder 58 include APACHE XERCES (for parsing in Java or C++), and TAO ORB or JAC ORB may be used as the CORBA pipe 50.

The second side also includes the measurement device 60, which measures the measured network 70 based upon the request from the client 12, to generate raw measurement data. This measurement is performed according to a particular protocol, and may be intervalized (taken as samples) or non-intervalized. The measurement device 60 may measure such items as protocol vitals, packet loss, packets per second, dropped packets, etc., as discussed above. As an example, the measured network 70 may be a communications network, however, other types of networks may be measured. The measurement device 60 may be a hardware device, or a software device, and in either case, may correspond to a Uniform Resource Link (URL). Although not shown in FIG. 2, it is noted that the communications network 1 of FIG. 2 may include a plurality of the measurement devices 60, each generating the raw data according to a different protocol.

The raw measurement data is encoded by a second side encoder 56. In this example, the second side encoder 56 is an XML document writer to encode the raw measurement data into an XML format. However, other protocol-independent formats may be used. The encoded raw data is then relayed to the CORBA pipe 50, the container 42, the IP network 30, the transporter 20, and to a first side decoder 18. In this example, the first side decoder 18 is an XML document parser, which extracts the encoded raw data from the XML format. The decoded measurement data is then transported via the router 14 to the client 12.

FIG. 2 illustrates a communications network which includes the FTP API 102, the FTP transporters 104, 106 and the SNMP transporters 122,124. The communications network 1 according to the present invention may also be achieved without including these elements. However, when these elements are included, it is necessary to also include the router 14 to route the client requests along the appropriate path. For example, the client 12 may request a file instead of measurement data. In this case, the router 14 will route the request to the FTP API 102. The router 14 chooses between the first side encoder 16 and the first SNMP transporter 122 based upon various parameters, including a specific request by the client 12, or attributes of the measuring device 60. For example, the measurement device 60 may not support SNMP, and therefore the request would be routed to the first side encoder 16.

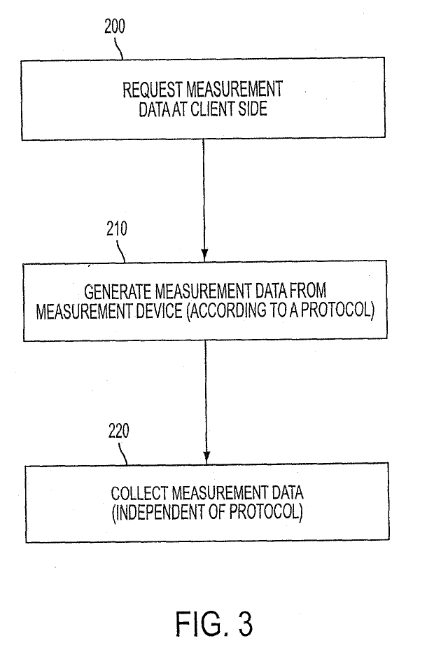

FIG. 3. is a flow diagram of the operation of the network 1 of FIG. 2. The client 12 requests the measurement data (operation 200), which is generated by the measurement device 60 according to the protocol (operation 210). The client 12 then collects the measurement data independent of the protocol (operation 220).

Thus, the network of FIG. 2 is a heterogeneous network which can operate independent of the protocol of the measurement device 60. Thus, the measurement device 60 may be easily changed, and additional measurement devices may be added. The network 1 is easily integrated to measure different networks of different clients, without the need for customization.

Although the above example describes encoding into XML form, the present invention is not limited to XML, and other forms may be used in order to allow for protocol independent data collection. Furthermore, VQTs or DNAs have been described as measuring devices, however, other devices which measure networks may be used to measure a variety of different networks. These networks may be wireless, wired, WAN, LAN, the Internet, or any combination thereof, without being limited to these examples.

Although a few preferred embodiments of the present invention have been shown and described, it will be appreciated by those skilled in the art that changes may be made in these embodiments without departing from the principles and spirit of the invention, the scope of which is defined in the claims and their equivalents.

What is claimed is:

1. A method of collecting measurement data in a system including a client side and a measurement device, the method comprising:
requesting the measurement data at the client side;
generating the measurement data from the measurement device according to a protocol, in accordance with the request; and
collecting the generated measurement data at the client side independent of the protocol.

2. The method of claim 1, wherein the generating of the measurement data comprises:
generating raw data according to the protocol; and
converting the generated raw data into the measurement data, comprising encoding the generated raw data into XML form.

3. A communications network to transmit measurement data having a protocol, the communications network comprising:
a first side to generate a request for the measurement data and to collect the measurement data independent of the protocol; and
a second side to generate the measurement data in response to the request.

4. The communications network of claim 3, wherein the second side is a server side, comprising:
a measurement device to evaluate an external network and generate raw data therefrom, in accordance with the request; and
an encoder to encode the generated raw data into encoded data.

5. The communications network of claim 4, wherein the encoder encodes the generated raw data into XML form.

6. The communications network of claim 5, wherein the first side is a client side, comprising:
a decoder to decode the encoded data into the measurement data.

7. The communications network of claim 6, wherein the first side further comprises a non-SNMP transporter to transport the request to the second side.

8. The communications network of claim 7, wherein the second side further comprises a servlet container to receive the transported request from the non-SNMP transporter.

9. The communications network of claim 5, wherein the first side further comprises a first FTP transporter to transport a request for file data generated by the first side, and the second side further comprises a second FTP transporter to transport the requested file data to the first FTP transporter.

10. The communications network of claim 7, wherein the first side further comprises a first SNMP transporter to transport the request, and the second side further comprises a second SNMP transporter to transport the requested measurement data from the measurement device to the first SNMP transporter.

11. The communications network of claim 10, wherein the first side generates a plurality of the requests for the measurement data, and the first side further comprises a router to route each of the requests to the SNMP transporter or the non-SNMP transporter.

12. The communications network of claim 4, further comprising a URL corresponding to the measurement device.

13. The communications network of claim 7, wherein the non-SNMP transporter is a HTTP transporter, a SMTP transporter, or a SOAP transporter.

14. The communications network of claim 3, further comprising an IP network to connect the first and second sides.

15. The communications network of claim 4, further comprising a plurality of the measurement devices, each of the measurement devices to generate the raw data according to a different protocol.

16. A communications network to transmit measurement data according to a request from a client, the communications network comprising:
a first side, comprising:
a first encoder to encode the request into an XML format, and
a transporter to transport the encoded request; and
a second side, comprising:
a container to receive the transported request,
a second decoder to decode the received request,
a measurement device to generate raw data in accordance with the decoded request, and
a second encoder to encode the generated raw data into the XML format.

17. The communications network of claim 16, wherein the container transports the encoded raw data to the transporter.

18. The communications network of claim 17, wherein the first side further comprises a first decoder to decode the encoded raw data into the measurement data.

19. The communications network of claim 18, wherein the client collects the decoded measurement data independent of a protocol of the raw data.

20. The communications network of claim 18, further comprising a plurality of the measurement devices, each of the measurement devices to generate the raw data according to a different protocol.
